(19) United States
(12) Patent Application Publication
(10) Pub. No.: US 2011/0179480 A1
(43) Pub. Date: Jul. 21, 2011

(54) System and method to protect web forms against spam messages using Tokens instead of using CAPTCHAs

(76) Inventor: Emanuele Rogledi, Certosa di Pavia (IT)

(21) Appl. No.: 12/690,195

(22) Filed: Jan. 20, 2010

(51) Int. Cl. G06F 21/00

(52) U.S. Cl. 726/14

(57) ABSTRACT

The problem we solve with this system is the spam on website's forms. Until now this problem has been solved with CAPTHCHAs that help to distinguish between the human users and spambots [0003]. The CAPTHCHAs approach is not a good solution because it does not prevent spambots to read and understand the content of CAPTCHAs. So web sites have to use more and more difficult CAPTCHAs, but human users can't read and understand them.

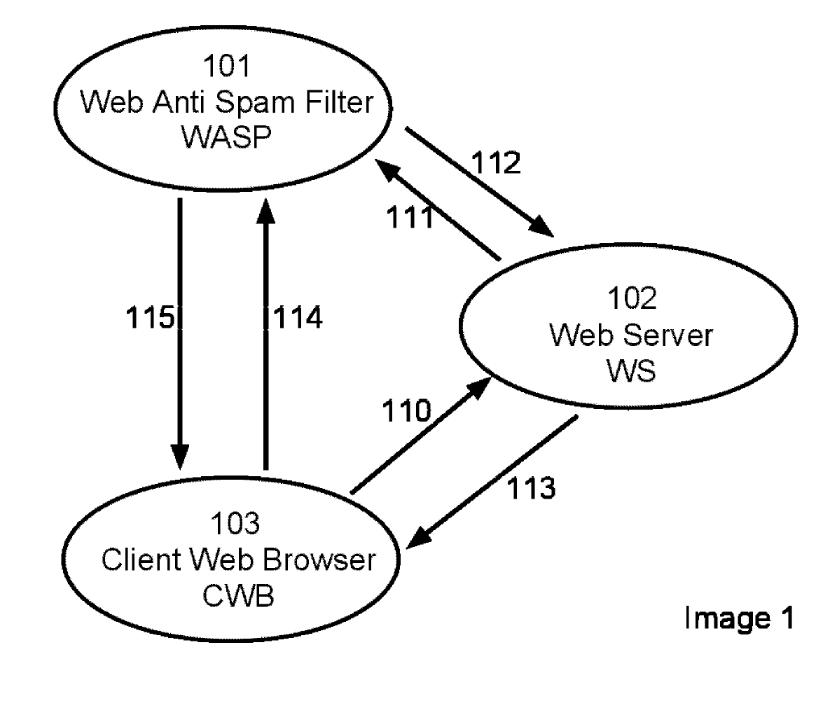

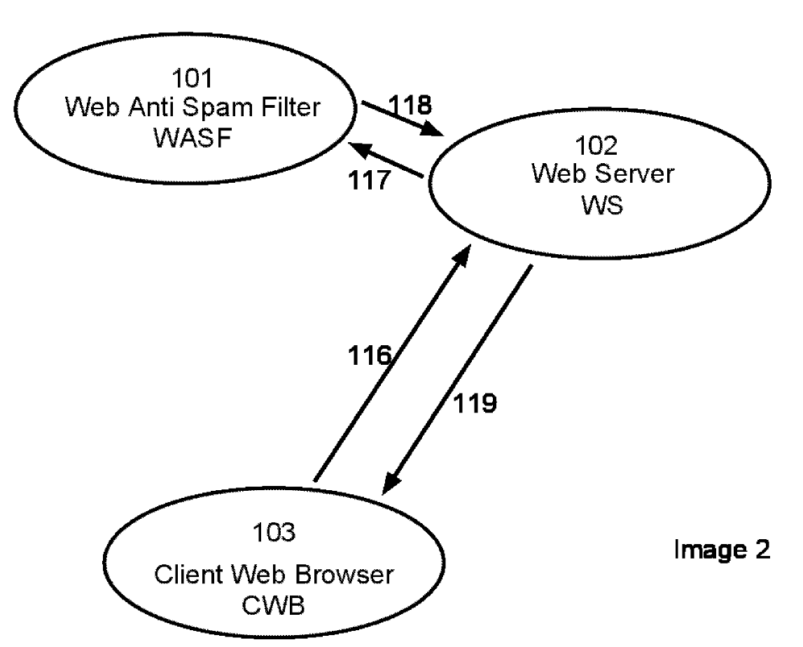

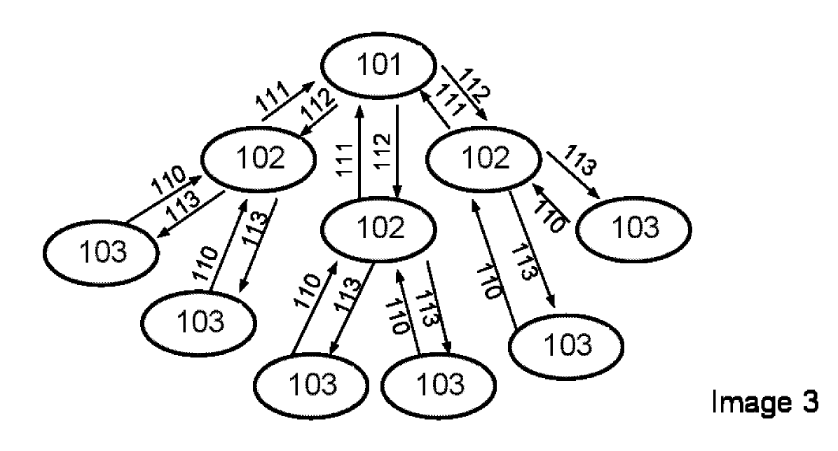

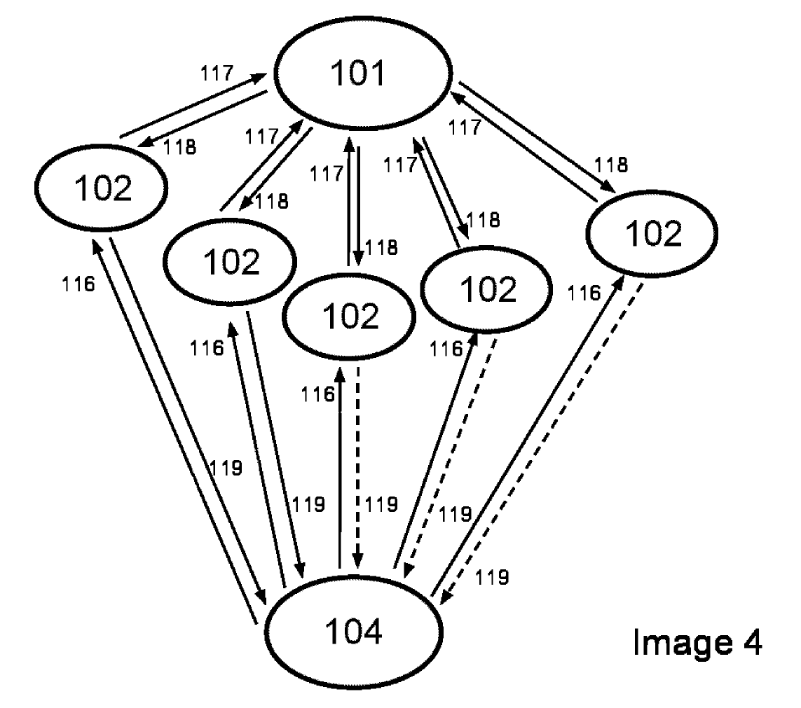

The system, that is described here, provide a solution completely different to avoid spam on web's forms without annoying the human users. The spread of smart-phones increase the needs of an automatic anti spambot filter.

When a web site receive a form compilation request ask to the system if it is a human user or a robot. The system check it without requiring the user to do anything. The system can work underneath the web page or it can publish an image on the web page. This image can be an advertising message.

### LEGEND

Spam: unsolicited or undesired email messages delivered directly to web sites' forms—forums, social networks, etc.

Spammer: the person who sends spam (see sketch n^{o} 104 here-below).

Spambot: is a software used by spammers to send great quantities of spam messages.

Web Server: is a computer program that delivers content, such as web pages, using the Hypertext Transfer Protocol. It is referred as element 102 in the following drawing.

Web Site: is a collection of related web pages, forms, images, videos or other digital assets that are addressed with a common domain name or IP address in an Internet Protocol-based network.

Web Anti Spam Filter (WASF): is one element of the system described in this document. It is referred as element 101 in the following drawing.

Web Form: a webform on a web page allows a user to enter data that is sent to a server for processing. Webforms resemble paper forms because internet users fill out the forms using checkboxes, radio buttons, or text fields.

Client Web Browser (CWB): is the web browser installed on the client computer. It is referred as element 103 in the following drawing.

CAPTCHAs: it is a type of challenge-response test used in computing to ensure that the response is not generated by a computer.

Semantic CAPTCHAs: instead of challenge-response test requires a logic answer, difficult to find for spambots but really easy for human beings.

Security Image: it is an image generated by WASF. This image might contain an advertising message.

Ticket: is a number generated by a network server for a client, which can be delivered to itself, or a different server as a means of authentication or proof of authorization, and cannot easily be forged.

### BRIEF SUMMARY OF THE INVENTION

The invention is an automatic system and method for protect web forms against spammer. We describe this system in two phases as follows.

Phase 1 (see image 1)

The phase 1 has 4 steps.
1. [110] the client web browser requests a page to a web site that contains a form,
2. [111] the web site asks for a ticket to the WASF for that specific web page,
3. [112] the WASF answer the web site with a ticket and a link to the WASF web site,
4. [113] the web site answer the client web browser request adding to the web page the WASF ticket and an image link:
   a. the ticket as a field inside the web form, for example: <input type=“hidden” name=“_token_” value=“f065b51 db9c592bf6ef66a76e9f8d0”/>,
   b. [114] an image link pointing to WASF web site, that is identified with the reference of this ticket, for example: <img src=“http://get.wasf.tld/?f065b51 db9c592bf6ef66a76e9f8d0” alt=“An example image”/>
5. [115] as soon as the client web browser receive the web site answer it automatically downloads the image from WASF and the web anti spam filter can validate the client reliability.
   Phase 2 (see image 2)

The phase 2 has 3 steps.
6. [116] the client web browser fill the form on the web page it send it back to the web site,
7. [117] the web site asks to WASF whether the client is human being or is a spambot,
8. [118] the WASF answer with a rate of spambot likelihood,
9. [119] the web site answer to the client form submission according to the spambot likelihood.

### FIELD OF APPLICATION OF THE INVENTION

The natural environment of the system described here is a public and widely used web on internet network. In particular this system works together with HTTP protocol and HTML web pages. With the help of this system it is possible to solve the problem of web forms spam, without using CAPTCHAs. The invention has been mainly thought as an automatic solution against spam messages in the internet web forms.

### BRIEF DESCRIPTION OF THE SEVERAL VIEWS OF THE DRAWING

Image 1 shows how in general the exchange of data is supplied in the phase 1 of the system, from the client web browser request to fill a web form, to the web site answer with the form plus a ticket and image link.

Image 2 shows how the exchange of date is supplied in the phase 2 of the system, from the client web browser that submit the form, to the answer of web site. Please note that this answer [119] is not under the system control.

Image 3 shows how the system works. There are many clients [103] that request forms and post data forms to web sites [102], through the WASF [101] anti spambot check.

Image 4 shows how the system works to detect a spammer. The spammer [104] tries to post spam messages to lots of web sites [102]. When the WASF [101] sees that the same data post is repeated, it detects the spammer and prevent it to posts more spam messages [118].

### BACKGROUND OF THE INVENTION

The System was conceived in order to permit an easy use of web sites' forms but preserve them from spammers. Users fill the forms and post them to web sites without any complication like CAPTCHAs, that are difficult for normal users, very difficult for old people and almost impossible for people with some kind of disabilities. Furthermore CAPTCHAs are very difficult for everybody on smart-phones.

Why this System Might be Interesting for Advertising Business.

The System needs an automatic image download to the client web browser [115]. This image can be just a pixel or can be an advertising message according to the web site agreement. So this System is very interesting for advertising business, because it allow to verify whether the advertising message reached the client web browser. The widespread of“hosts files” and “anti advertising server” systems allow the skillful users to explore web pages of many sites without the advertising banners. The system sends the images with absolute certainty to the client browser and it assures that the images are downloaded on client web browser.

Why this System Might be Interesting for Web Sites' Administrators.

Finally web site administrators have the possibility to get rid of spambots. They can accept data information from web forms, without the CAPTCHAs difficulties. CAPTCHAs are so hard for a lots of users, but are a piece of cake for spambots, that can use advance OCR tools to understand CAPTCHAs and send spam easily on the web forms.

Ultimately CAPTCHAs:
are very tiresome for users who have to lose time to fill them up correctly and often have to repeat it several times,
increase web sites managing costs, requiring continuous update work,
reduce the web site revenue, because some users don't want deal with them,
are very frustrating for people with disabilities.

The WASF system is a win-win solution for web sites and advertising business. The web pages could be easily filled with information and the advertise can be focus on the web page contest and users data on web forms. The web sites business can grow because advertising business know that their messages surely reach the clients and are focus on their needs, for example the web site can earn money even using the sing up process.

The WASF system is free for web sites administrators, otherwise than CAPTCHAs, because the system will be paid by advertising messages.

When a web site administrator adopt the WASF system does not need any other spambot protection system.

### DETAILED DESCRIPTION OF THE INVENTION

Since the web has been created, the web pages are written using HTML language which, even is simple and bright, has always suffered for the lack of a concrete managing of the protocol state. Due to the above lack, the web has been suffering continuous attacks from spammers trying to introduce the greatest number of messages on the web sites.

The web sites administrators adopted a defensive tools based on distinction between human users and spambots between who were trying to access theirs web sites. The widespread tools is CAPTCHAs, that hide a message inside an image, hoping that only human being can understand that message. But a lot of spambots can use OCR systems to by-pass CAPTCHAs. There are even companies that hire people to decrypt CAPTCHAs for the spammers.

The WASF system works in two different phases:

phase 1, see image 1, from step 1 to 5,

phase 2, see image 2, from step 6 to 9.

Phase 1:
1. client web browser requests to fill a web form (step 110) to the web site,
2. the web site asks WASF system to submit a ticket (step 111),
3. WASF sends the reply to the web site (step 112),
4. the web site send to client web browser the web form with a ticket and a link to an image (step 113),
5. the client web browser automatically go to the WASF web site (step 114),
6. and download and than load the image on client web browser (step 115),

The steps (114) and (115) can be optional.

The WASF system can works with only steps (111) and (112) whether the web site prefer to pay directly the WASF system service.

Phase 2:
7. the client fill in the web form and submit to the web site (step 116),
8. the web site send all the information in the web form, included the ticket, to the WASF system (step 117),
9. the WASF system analyse the data and answer to the web site with the spambot likelihood (step 118),
10. the web site decide what to do with client according to the spambot likelihood.

In consideration of what above explained, the following intellectual rights are claimed:

1. We are hereby claiming the intellectual rights of an advertising on line system based on computers which includes:
a. A generator for security images originating images with or without an embedded advertisement, to be seen in a web page,
b. A system to detect spam messages,
c. A system to select spam messages.

2. We are hereby claiming the intellectual rights referring to point 1 about a different kind of advertising messages not seen as simple images, taking advantage from the same basic concept allowing the web form to be treated safely.

3. We are hereby claiming the intellectual rights of an automatic anti spam filter for web forms.

4. We are hereby claiming the intellectual rights of an automatic anti spam filter for web forms that calculate the spambot and human being likelihood.

5. We are hereby claiming the intellectual rights of an automatic anti spam filter for web forms that analyse the web forms data and detect IP address of the client web browser.
